(19) United States
(12) Patent Application Publication
(10) Pub. No.: US 2008/0298422 A1
(43) Pub. Date: Dec. 4, 2008

(54) Dye Laser Medium, Dye Laser Device, and Laser Sensor

(75) Inventors: Tsuyoshi Kawai, Ikoma-shi (JP); Takuya Nakashima, Ikoma-shi (JP)

Correspondence Address: OLIFF & BERRIDGE, PLC, P.O. BOX 320850, ALEXANDRIA, VA, 22320-4850, US

(73) Assignee: NATIONAL UNIVERSITY CORPORATION NARA INSTITUTE OF SCIENCE AND TECHNOLOGY, Ikoma-shi, Nara (JP)

(21) Appl. No.: 12/087,589

(22) PCT Filed: Jan. 26, 2007
(86) PCT No.: PCT/JP2007/000034

§ 371 Date: Jul. 10, 2008

(30) Foreign Application Priority Data
Feb. 1, 2006 (JP) 2006-024081

(51) Int. Cl. H01S 3/20

(52) U.S. Cl. 372/53

(57) ABSTRACT

Although having been used for conventional dye laser solvents, organic solvents have a disadvantage of volatility and inflammability, which makes a dye laser device large and cumbersome. In the present invention, which has been developed to solve this problem, an ionic liquid is used as the dye laser solvent. An organic dye stably dissolves in an ionic liquid and the light-emitting property is almost comparable to the case where an organic solvent is used. Since ionic liquids do not have volatility and inflammability, the dye laser medium according to the present invention is extremely easy to handle. In addition, it also has a property that the photobleach is extremely low compared to conventional dye laser mediums using an organic solvent as the solvent thereof. It is easy to obtain a laser sensor for detecting a predetermined specimen with high sensitivity using the dye laser medium according to the present invention.

### TECHNICAL FIELD

The present invention relates to a dye laser medium and a sensor using the dye laser medium.

### BACKGROUND ART

A dye laser is widely and commonly used since it has an advantage that a wavelength tuning can be continuously performed, by selecting the dye's kind, across a wide wavelength range centering on a visible range.

Today, in a dye laser medium, an organic solvent such as ethanol which has a good solubility to an organic dye is used as a solvent for dissolving a dye. However, a dye laser has many kinds of problems caused by the organic solvent. For example, organic solvents have a problem in that the dye concentration changes as time progresses because of its high volatility. In addition, bubbles may be generated in the strong excitation, which makes performing a stable oscillation difficult. Furthermore, most organic solvents have flammability caused by its volatility, which is always associated with the risk of an explosion. For this reason, a dye laser device has a disadvantage in that it requires a cooling circulating unit for preventing overheating so that the laser medium's temperature will not excessively rise in emitting an excitation light to thereby cause a laser emission.

Given this factor, alternative techniques aimed at preventing the problems as previously described have been strongly studied and disclosed.

Patent Document 1 discloses, for example, a technique in which an organic dye is dissolved in a high-boiling water-soluble organic solvent including water. In this technique, a nonflammable solvent is used by utilizing a surface active agent.

Patent Document 2 discloses a method for manufacturing a solid laser medium in which an organic dye for laser oscillation is dispersed and held in the matrix formed by a condensation polymerization of a silane-derivative-containing hydrolyzable material. The solidification of a laser medium achieves an easy handling of the laser medium.

[Patent document 1] Japanese Unexamined Patent Application Publication No. H11-204892

[Patent document 2] Japanese Unexamined Patent Application Publication No. H6-244510

[Patent document 3] Japanese Unexamined Patent Application Publication No. 2002-3478

### DISCLOSURE OF THE INVENTION

### Problems to be Solved by the Invention

However, the method of Patent Document 1 still has the problem that the solvent evaporates. The method of Patent Document 2 has the problem that the dye's cohesion often occurs in the matrix because of the compatibility of the laser pigment and matrix. Although various kinds of experiments and studies have been done in addition to these, a dye laser medium that is easy to use and stable in property has not been in existence until now.

The present invention is achieved to solve the problems as previously described and the purpose thereof is to obtain an easy-to-use, property-stable, and long-lasting dye laser medium.

### Means for Solving the Problems

To solve the previously-described problems, the present invention provides a dye laser medium in which an organic dye is dispersed in an ionic liquid.

An ionic liquid is a kind of a solvent having the properties of nonvolatility, nonflammability, and high ion-conductivity, and various kinds of ionic liquids have been researched and developed. For example, Patent Document 3 discloses a cation-forming compound which can obtain a low-viscosity liquid having a high solvency particularly to biopolymers and molecular assemblies. However, including what is disclosed in Patent Document 3, using an ionic liquid as a medium for a dye laser has conventionally neither been disclosed nor suggested.

The inventors of the present application have devoted research focusing attention on the fact that an ionic liquid has properties as just described which are different from those of conventional organic solvents and also on the fact that an ionic liquid can stably make various kinds of organic dyes dissolve since it has a polar character similar to that of ethanol. As a result, an invention has been developed in which an ionic liquid is used as a medium for a dye laser.

In addition, the inventors of the present application have focused attention on the excellent medium absorbability of the dye laser medium according to the present invention and reached a sensor which preferably utilizes the dye laser medium according to the present invention. The laser sensor is characterized in that it includes:

a sensor unit composed of a dye laser medium in which an organic dye is dispersed in an ionic liquid;

an emitter for emitting an excitation light to the sensor unit; and

a detector for performing a predetermined detection operation based on a property change of a dye laser emitted from the sensor.

### Effects of the Invention

The dye laser medium according to the present invention has excellent advantages such as:

1) It has a better durability against the photodecomposition than mediums where an organic solvent is used as a solvent. Hence, it has a long medium life duration.

2) Since an ionic liquid is nonvolatile, the variation of a dye concentration in accordance with the solvent's volatilization does not occur in the dye laser medium according to the present invention.

3) Since an ionic liquid is nonvolatile, bubbles are not generated even in the strong excitation in the dye laser medium according to the present invention, which stabilizes a laser oscillation.

4) Since an ionic liquid has very low flammability and ignitability, a cooling circulating unit, which is indispensable in the case where an organic solvent is used as a solvent, can be omitted. Therefore, it is possible to omit the operation for changing a medium, which has conventionally required considerable time and labor, in order to change an oscillation wavelength in a dye laser device.

The laser sensor according to the present invention has an advantage that, although its configuration is very simple, it can obtain a high detection sensitivity. The specimen molecules absorbed inside the dye laser medium can easily be removed by a heating method or decompression exclusion method. Therefore, the sensor unit can be reused many times and the detection capability will not easily decrease after repeated use.

### BRIEF DESCRIPTION OF THE DRAWINGS

FIG. 1 is a schematic configuration view of the laser sensor according to the present invention.

FIG. 2 is a graph illustrating an example of the emission intensity's change before and after the absorption of a specimen.

FIG. 3 is a structural formula of rhodamine 6G.

FIG. 4 is a structural formula of bmimTFSI.

FIG. 5 illustrates the absorption spectra of an ethanol solution and ionic liquid solution.

FIG. 6 illustrates the emission spectra of an ethanol solution and an ionic liquid solution.

FIG. 7 illustrates graphs showing fluorescence intensities before and after the emission of a light beam of a mercury xenon lamp.

FIG. 8 illustrates emission streak images from outside a cavity and inside the cavity in the case where an ionic liquid solution is excited by a nitrogen laser.

FIG. 9 illustrates laser emission wavelength profiles of an ionic liquid solution exposed under a nitrobenzene atmosphere and a non-exposed ionic liquid solution.

### EXPLANATION OF NUMERALS

1 . . . Sensor Unit
2 . . . Emitter
3 . . . Detector

### BEST MODE FOR CARRYING OUT THE INVENTION

The dye laser medium according to the present invention uses an ionic liquid as the medium for a dye laser.

Since the polar character of an ionic liquid is similar to that of ethanol as previously described, various kinds of organic dyes generally used as a dye for a laser medium can be used for the dye laser medium according to the present invention. For example, the organic dye includes organic dyes in which a pi-conjugated system is developed and metallic organic dyes.

Although the ionic liquid used for the dye laser medium according to the present invention may be any of the various kinds of conventionally-known ionic liquids, it may preferably be liquid under the temperature conditions in the vicinity of room temperature and be stable enough not to decompose nor deteriorate even in air. As concrete examples, preferable ionic liquid includes those composed of a cation represented by any one of the following general formulae (1) through (4) and an anion (A⁻):

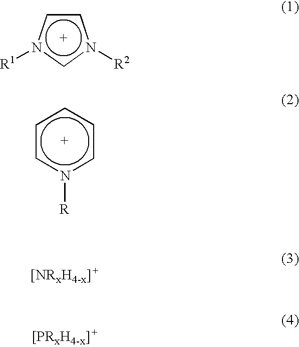

where R represents, in the formulae (1) through (4), an alkyl group whose carbon number is not more than 12 or an alkyl group, which includes an ether linkage, in which a total number of carbon and oxygen is not more than 12; R¹ and R² each represents, in the formula (I), a functional group including a C1-C4 group and either one of or both of R¹ and R² include not less than one double bond; R and R¹ or R² may preferably not be identical in the formula (1); and x represents an integer of 1 to 4 in the formulae (3) and (4). As the anion (A⁻), for example, at least one kind selected from the following may be used: bis(trifluoromethylsulfonyl)imidic acid, perchloric acid, tetrafluoroboric acid, hexafluorophosphoric acid, tris(trifluoromethylsulfonyl)carbon acid, trifluoromethanesulfonic acid, dicyanamide, trifluoroacetic acid, organic carbonyl acid, and halogen ions.

It is also possible to solidify the dye laser medium by using a polymerizable ionic liquid.

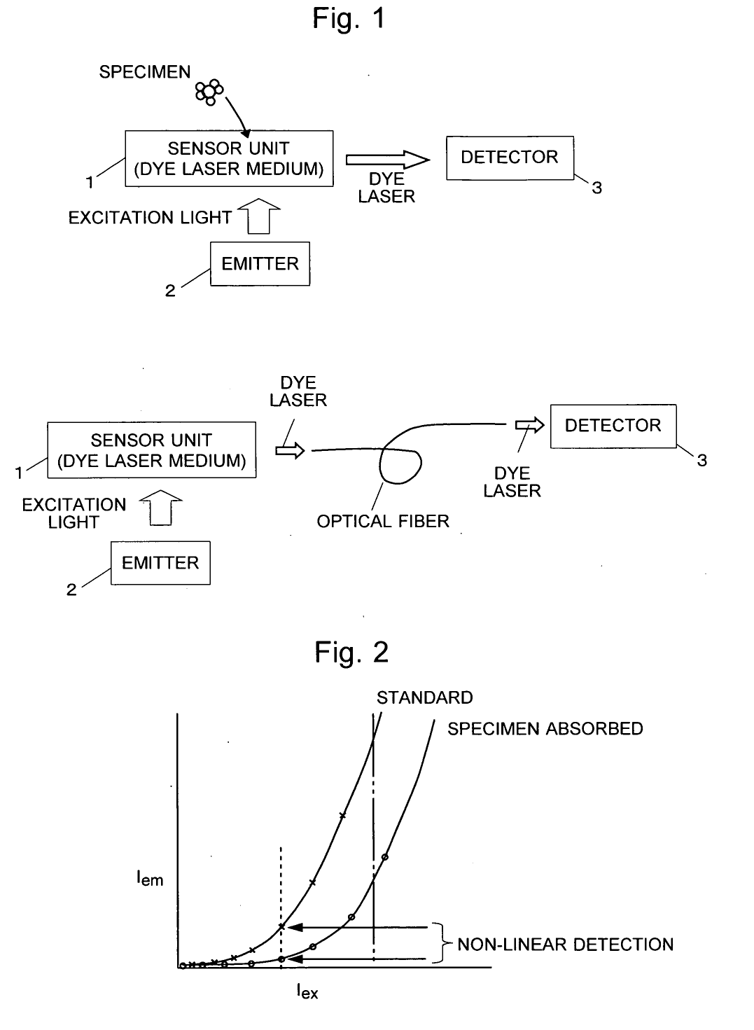

In addition, it is possible to obtain a high-performance atmospheric exposure laser sensor by using the dye laser medium according to the present invention. Hereinafter, this laser sensor will be explained with reference to FIG. 1.

An ionic liquid is capable of absorbing various kinds of gaseous molecules. Given this factor, if a dye laser medium where an organic dye is dispersed in an ionic liquid, which serves as the sensor unit 1, is exposed to air or to a predetermined atmosphere, specimen (and other gases) molecules are absorbed into the dye laser medium. If the dye laser medium is manufactured with an organic dye which corresponds to the properties of the specimen to be detected, the properties of the dye laser which is a light obtained by emitting an excitation light from the emitter to the dye laser medium changes between before-absorption and after-absorption of the specimen. The laser sensor according to the present invention detects a specimen by using this property's change.

The dye laser's intensity can be used as the property of the dye laser. FIG. 2 is a graph illustrating an example of the emission intensity's change, i.e. the dye laser intensity's change, before and after the absorption of a specimen. The horizontal axis is assigned to the excitation light intensity, and the vertical axis to the dye laser intensity. FIG. 2 shows that, after the dye laser medium of the sensor unit 2 absorbs the specimen, the dye laser intensity decreases compared to the state before the absorption (“standard”). In the graph of FIG. 2, the proportion of the dye laser intensity before absorption to the dye laser intensity after absorption in the portion where the excitation light intensity is relatively low (as indicated with a dashed line) is larger than that in the portion where the excitation light intensity is high (as indicated with a two-dot chain line). By using this proportion, it is possible to perform a high-sensitive specimen detection. That is, the excitation light intensity may be properly set in the area where the dye laser intensity changes in a nonlinear manner, as the portion indicated with the dashed line of FIG. 2.

In addition, as the property of a dye laser, the frequency of the peaks of the dye laser may be used. Since a spectrum of a dye laser is generally sharp, even a slight change of wavelength can be detected; i.e. the detection sensitivity is high.

In the detector 3 of the laser sensor, a reference value for the dye laser's property change as previously described may be set in advance. For example, in the case where the specimen's detection is performed with the dye laser's intensity change, a detection action for informing a user that the specimen is detected may be performed, such as: a message is displayed when the emission intensity becomes lower than a predetermined value.

Thanks to the ionic liquid's property, the specimen molecules absorbed in the dye laser medium can be easily removed with a heating method or decompression exclusion method. That is, the dye laser medium can be used repeatedly.

The laser sensor according to the present invention detects a specimen based on a dye laser which is a laser light. Hence, as illustrated in the lower portion of FIG. 1, the sensor unit 1 and emitter 2 are placed in proximity, or they may be integrated. The dye laser provided from the sensor 1 is transmitted to a distance through an optical fiber or by other methods. Then the detector 3 receives the dye laser transmitted through the optical fiber and measures its property. This achieves the configuration where the sensor 1 and detector 3 are separated, and accordingly the configuration's flexibility of the laser sensor is increased. In particular, the present configuration is effective in the case where the detection target is a noxious gas or the like.

### EXAMPLE

Hereinafter, an experiment that the inventors of the present invention have done will be explained. The experiment has been performed in order to confirm the property of the dye laser medium according to the present invention.

### (Dye Laser Medium's Spectral Property)

The properties between a dye laser medium in which an organic dye is dispersed in an ionic liquid and a conventional dye solvent in which organic dye is dispersed in ethanol were compared.

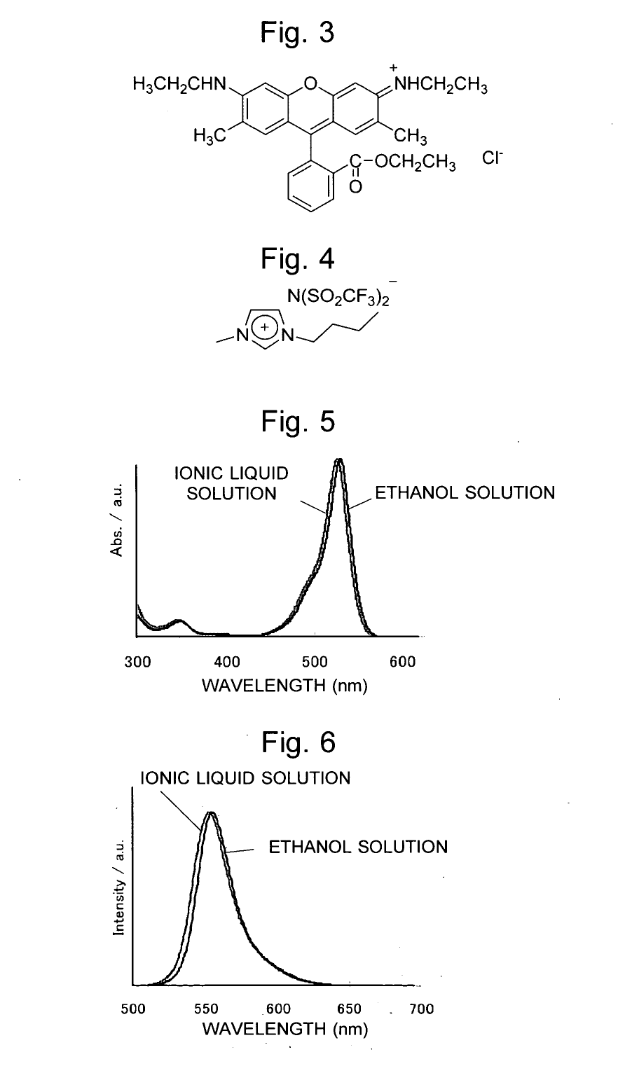

Rhodamine 6G (FIG. 3) was used as the dye, and the Rhodamine 6G were dissolved in each of ethanol and bmimTFSI (FIG. 4), which is an ionic liquid, in a concentration of 10 μM. It was confirmed that Rhodamine 6G is stably dispersed in bmimTFSI in a concentration of 1.5 mg/ml or more which is used for a laser medium.

Hereinafter, the former will be called an ethanol solution, and the latter an ionic liquid solution.

FIG. 5 illustrates the absorption spectra of the ethanol solution and ionic liquid solution, and FIG. 6 illustrates the emission spectra of the ethanol solution and an ionic liquid solution.

Compared to the ethanol solution, the ionic liquid solution was blue shifted by approximately 3 nm in both absorption and emission. The fluorescence quantum yield corrected by a refractive index was 97% in the ionic liquid solution and an extinction was hardly observed. That is, it was confirmed that rhodamine 6G shows the same light-emitting property in the ionic liquid solution as that in a polar solvent (organic solvent). This result primarily shows that the dye laser medium according to the present invention can be a substitute for conventional dye mediums.

### (Dye Laser Medium's Durability Against the Photodecomposition)

An ethanol solution and ionic liquid solution prepared with the same method as previously described were put in a 3 ml cell, and nitrogen bubbling was performed for three minutes. After that, a light beam of a mercury xenon lamp was emitted and the fluorescence intensity's change was observed.

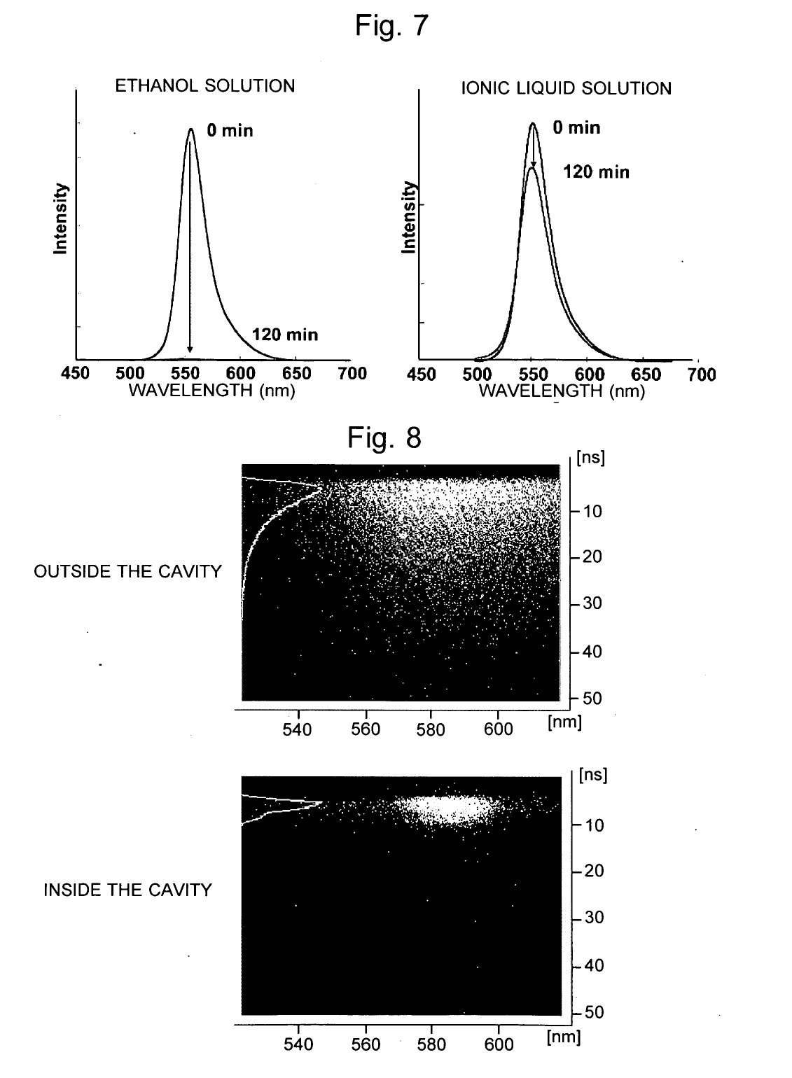

FIG. 7 illustrates graphs each showing the fluorescence intensity before the emission of the light beam of a mercury xenon lamp and after 120 minutes of emission. In FIG. 7, the left graph illustrates the fluorescence intensity of the ethanol solution, and the right graph illustrates that of the ionic liquid solution.

In the ethanol solution, as illustrated in FIG. 7, the fluorescence intensity decreased to approximately 3% by the 120 minutes' emission of the light beam of a mercury xenon lamp. On the other hand, in the ionic liquid solution, the decrease width remained approximately 10%. This shows that the dye laser medium according to the present invention has an extremely high durability against the photodecomposition.

### (Laser Oscillation Behavior)

In order to exemplify that the ionic liquid solution can be used as a laser medium, a laser oscillation behavior was evaluated with a nitrogen-dye laser by using an ionic liquid solution in which rhodamine 6G was dissolved in a concentration of 1.5 mg/ml. FIG. 8 illustrates time-resolved fluorescence streak images in the case where the ionic liquid solution was excited by a nitrogen laser (337 nm). Each image was obtained with the ionic liquid solution being placed outside the cavity (the upper image) or inside the cavity (the lower image).

As illustrated in FIG. 8, a normal fluorescence which decays with the lifetime of 5.8 nm was observed from the sample placed outside the cavity. On the other hand, the narrowing of the emission time and emission profile was observed in the case where the sample was inside the cavity. That is, a laser oscillation was confirmed.

### (Confirmation of the Laser Sensor Property)

Rhodamine 6G was dissolved in an ionic liquid solution in a concentration of 1.65 g/l, and the ionic liquid solution thus prepared was preserved in a desiccator under nitrobenzene atmosphere. Rhodamine 6G-ionic liquid solution obtained in this manner was placed in a resonator and excited by a nitrogen laser (337 nm) to evaluate the laser property with a streak scope.

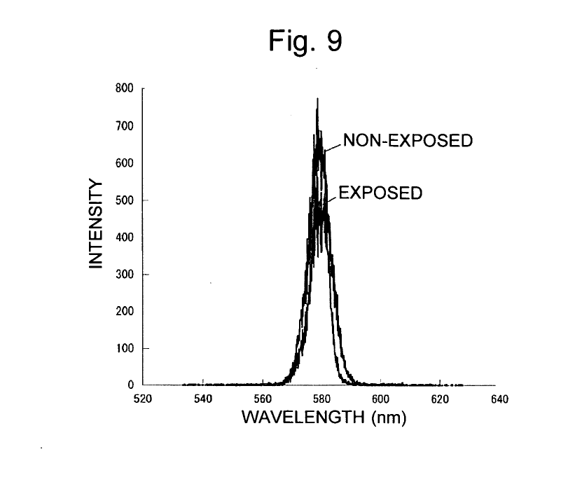

FIG. 9 illustrates the wavelength profiles of the laser emission provided from the rhodamine 6G-ionic liquid solution regarding the sample exposed and the sample non-exposed in the desiccator under nitrobenzene atmosphere. As is illustrated in FIG. 9, the intensity of the exposed sample decreased. That is, it was confirmed that an ionic liquid solution absorbs nitrobenzene. This shows that the dye laser medium according to the present invention preferably serves as a medium for a laser sensor.

1. A dye laser medium in which an organic dye is dispersed in an ionic liquid.

2. The dye laser medium according to claim 1, wherein the ionic liquid is composed of a cation represented by any one of the following general formulae (1) through (4) and an anion (A⁻): 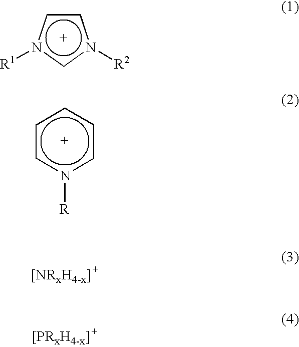
where R represents, in the formulae (1) through (4), an alkyl group whose carbon number is not more than 12 or an alkyl group, which includes an ether linkage, in which a total number of carbon and oxygen is not more than 12; R¹ and R² each represents, in the formula (1), a functional group including a C1-C4 group and either one of or both of R¹ and R² include not less than one double bond; and x represents an integer of 1 to 4 in the formulae (3) and (4).

3. A dye laser device using the dye laser medium according to claim 1 as an oscillation medium.

4. A laser sensor comprising:
a sensor unit composed of a dye laser medium in which an organic dye is dispersed in an ionic liquid;
an emitter for emitting an excitation light to the sensor unit; and
a detector for performing a predetermined detection operation based on a property change of a dye laser provided from the sensor unit.

5. The laser sensor according to claim 4, wherein the ionic liquid is composed of a cation represented by any one of the following general formulae (1) through (4) and an anion (A⁻): 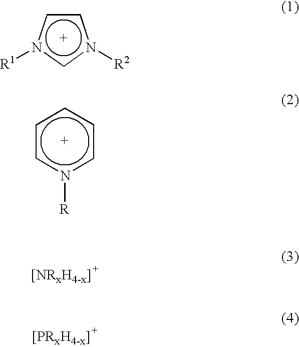
where R represents, in the formulae (1) through (4), an alkyl group whose carbon number is not more than 12 or an alkyl group, which includes an ether linkage, in which a total number of carbon and oxygen is not more than 12; R¹ and R² each represents, in the formula (1), a functional group including a C1-C4 group and either one of or both of R¹ and R² include not less than one double bond; and x represents an integer of 1 to 4 in the formulae (3) and (4).

6. The dye laser medium according to claim 2, wherein the anion is at least any one kind selected from the following: bis(trifluoromethylsulfonyl)imidic acid, perchloric acid, tetrafluoroboric acid, hexafluorophosphoric acid, tris(trifluoromethylsulfonyl)carbon acid, trifluoromethanesulfonic acid, dicyanamide, trifluoroacetic acid, organic carbonyl acid, and halogen ion.

7. The dye laser medium according to claim 1, wherein the ionic liquid is polymerizable.

8. A dye laser device using the dye laser medium according to claim 2 as an oscillation medium.

9. A dye laser device using the dye laser medium according to claim 6 as an oscillation medium.

10. The laser sensor according to claim 5, wherein the anion is at least any one kind selected from the following: bis(trifluoromethylsulfonyl)imidic acid, perchloric acid, tetrafluoroboric acid, hexafluorophosphoric acid, tris(trifluoromethylsulfonyl)carbon acid, trifluoromethanesulfonic acid, dicyanamide, trifluoroacetic acid, organic carbonyl acid, and halogen ion.
